(19) United States
(12) Patent Application Publication
(10) Pub. No.: US 2017/0152872 A1
(43) Pub. Date: Jun. 1, 2017

(54) GUIDE UNIT FOR ACTUATOR

(71) Applicant: SMC CORPORATION, Chiyoda-ku, Tokyo (JP)

(72) Inventor: Kazufumi WAKI, Moriya-shi (JP)

(73) Assignee: SMC CORPORATION, Chiyoda-ku, Tokyo (JP)

(21) Appl. No.: 15/321,106

(22) PCT Filed: May 22, 2015
(86) PCT No.: PCT/JP2015/064744

§ 371 Date: Dec. 21, 2016

(30) Foreign Application Priority Data
May 22, 2014 (JP) 2014-144725

(51) Int. Cl. F15B 15/14

(52) U.S. Cl. CPC F15B 15/1471

(57) ABSTRACT

A guide unit for an actuator includes a slide part and a guide part. The actuator includes a drive rod extending from a cylinder main body. The slide part includes: a slider detachably connected to the drive rod; and a guide rod fixed to the slider. The guide part includes: a guide plate fixed to the cylinder main body; and a guide tube fixed to the guide plate. The guide rod is slidably inserted into the guide tube.

### TECHNICAL FIELD

The present invention relates to a guide unit for an actuator, and in particular, a guide unit for a fluid pressure actuator.

### BACKGROUND ART

Heretofore, as a means for transporting a workpiece or the like, there has widely been used an actuator that drives a rod in an axial direction by means of a motor or a fluid pressure, and thereby displaces a slider that transports or conveys the workpiece.

The present applicant has proposed an actuator in which a guide unit equipped with a pair of guide rods is provided detachably on a drive unit, and in which, by connecting a connection plate, which is connected to the guide rods, to an end of a piston rod that makes up the drive unit, the guide rods are made to undergo displacement together with the piston rod (see, Japanese Laid-Open Patent Publication No. 2011-106489).

### SUMMARY OF INVENTION

The present invention has been devised in relation to the aforementioned proposal, and has the object of providing a guide unit for an actuator having a simple structure, in which it is possible to easily modify a bearing support span of guide rods, a mutual spacing (pitch) between the guide rods, and an outer diameter of the guide rods, depending on the size of a required load, an installation space, and the application of use thereof.

In order to achieve the above object, a guide unit for an actuator, which includes a slide member and a guide member, is characterized in that the actuator comprises a drive rod that extends out from a cylinder main body, the slide member includes a slider that is connected detachably to the drive rod, and guide rods that are fixed to the slider, the guide member includes a guide plate that is fixed to the cylinder main body, and guide tubes that are fixed to the guide plate, and the guide rods are slidably inserted through the guide tubes.

In accordance with the above-described guide unit, by changing the combination of the slider, the guide rods, the guide plate, and the guide tubes, it is possible to easily modify in a desired manner the outer diameter of the guide rods, a mutual spacing between the guide rods, or a bearing support span of the guide rods. In addition, the slider, the guide rods, the guide plate, and the guide tubes can be provided with simple configurations, respectively.

In the above-described guide unit, the guide plate preferably is constituted from a rectangular plate member, with attachment holes that penetrate in a thickness direction being formed in the corners thereof. In accordance with this feature, the guide plate can be made with a particularly simple structure.

Further, the guide plate may be constituted from a rectangular plate member, with attachment holes formed therein that penetrate from one side end surface to another opposite side end surface. In accordance with this feature, the guide plate can be made with a simple structure, and further, it is easy to attach the guide unit along a wall surface or the like of a device that serves as a member to which the guide unit is attached.

Furthermore, the guide plate may be constituted from a plate member having an L-shape in cross section, including a first plate section substantially perpendicular to the guide rods and a second plate section substantially parallel to the guide rods, and having attachment holes formed therein that penetrate in a thickness direction of the second plate section. In accordance with this feature, it is easy to manufacture the guide plate, and further, it is easy to attach the guide unit along a wall surface or the like of a device that serves as a member to which the guide unit is attached.

Further still, the slider preferably is connected to the drive rod through a floating mechanism. In accordance with this feature, even if attachment errors occur mutually between a piston rod, a cylinder main body, the guide member, and the slide member in directions perpendicular to the axis of the piston rod, such errors can be absorbed by the floating mechanism.

Further, the guide tubes preferably are fixed to the guide plate by any one of a bolt, screw fitting, and a retaining ring. In accordance with this feature, the guide plate and the guide tubes can freely be fixed and detached from one another, and in the case that the combination of the guide plate and the guide tubes is modified, one of such members can be reused.

Furthermore, the slider may be fixed to the drive rod by a bolt or a nut. In accordance with this feature, fixing of the slider and the drive rod is simple.

Furthermore, the guide rods may be fixed to the slider by any one of a bolt, screw fitting, caulking, and welding. In accordance with this feature, fixing of the guide rods and the slider is simple.

In accordance with the above-described guide unit for an actuator according to the present invention, by changing the combination of the slider, the guide rods, the guide plate, and the guide tubes, it is possible to easily modify in a desired manner the outer diameter of the guide rods, a mutual spacing between the guide rods, or a bearing support span of the guide rods. In addition, concerning each of the slider, the guide rods, the guide plate, and the guide tubes, respectively, simple shapes can be adopted therefor, manufacturing thereof is facilitated, and a reduction in cost is achieved.

### BRIEF DESCRIPTION OF DRAWINGS

FIG. 1 is a perspective view of a guide unit according to a first embodiment of the present invention;

FIG. 2 is a front view of the guide unit shown in FIG. 1;

FIG. 3 is a cross-sectional view taken along line III-III of the guide unit shown in FIG. 2;

FIG. 4 is a cross-sectional view taken along line III-III in a predetermined state of operation of the guide unit shown in FIG. 2;

FIG. 5 is a perspective view of a guide unit according to a second embodiment of the present invention; and

FIG. 6 is a perspective view of a guide unit according to a third embodiment of the present invention.

### DESCRIPTION OF EMBODIMENTS

Below, a detailed description will be presented with reference to the accompanying drawings of preferred embodiments of a guide unit for an actuator according to the present invention.

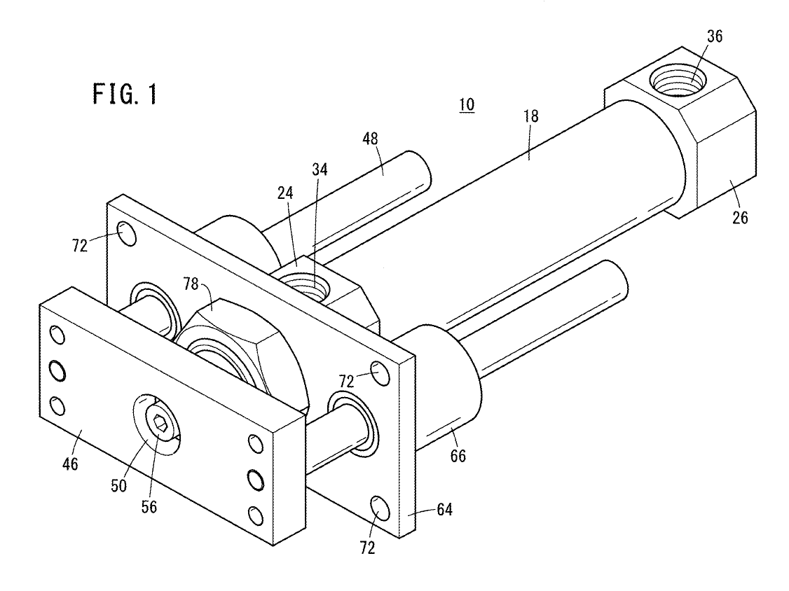

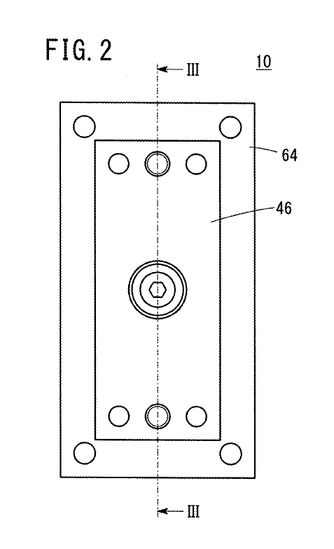

A guide unit 10 according to a first embodiment will be described with reference to FIGS. 1 through 4.

The guide unit 10 is constructed by combining therewith a fluid pressure actuator 12 such as, for example, a pneumatic cylinder, and includes a slide member 14 and a guide member 16.

The fluid pressure actuator 12 includes a cylinder tube 18, a piston 20, and a piston rod (drive rod) 22, etc. The piston 20 is disposed slidably in the cylinder tube 18. A cylindrical rod cover 24 is fitted and fixed in one end side of the thin-walled cylindrical cylinder tube 18, and a head cover 26 is fitted and fixed in the other end side of the cylinder tube 18, to thereby constitute a cylinder main body 28. A first pressure chamber 30 is formed between one end side of the piston 20 and the rod cover 24, and a second pressure chamber 32 is formed between the other end side of the piston 20 and the head cover 26. Air is supplied to and discharged from the first pressure chamber 30 and the second pressure chamber 32 through a first port 34 and a second port 36, respectively. A male threaded section 38 is included on an end of the rod cover 24 on an opposite side from the cylinder tube 18.

The piston rod 22 is connected to one end side of the piston 20, and the piston rod 22 extends out to the exterior through an inner part of the rod cover 24. A bottomed threaded hole 40 is formed in an end of the piston rod 22 that is extended out to the exterior. A piston packing 42 is disposed on an outer circumference of the piston 20. The piston packing 42 slides along an inner surface of the cylinder tube 18. A rod packing 44 is disposed on an inner circumference of the rod cover 24. The rod packing 44 slides along the piston rod 22 and preserves the airtightness of the first pressure chamber 30 from the exterior.

The slide member 14 includes a slider 46 and guide rods 48. The slider 46 is made up from an elongated rectangular plate and includes a circular first through hole 50 in the center thereof. The first through hole 50 is of a stepped shape, and an inwardly projecting flange section 52 is formed therein on a side proximate to the piston rod 22. In the vicinity of both ends in the longitudinal direction of the slider 46, second through holes 54 are formed at substantially the same distance from the first through hole 50. Female screw threads are formed in the second through holes 54.

The slider 46 is connected to the end of the piston rod 22 that projects out from the rod cover 24, using a first bolt 56, a flat first retaining ring 58, and a cross-sectionally L-shaped second retaining ring 60. The second retaining ring 60 includes a tubular part 59 that projects out from one surface of an annular plate portion thereof. An outer diameter of the tubular part 59 is smaller than the inner diameter of the flange section 52 of the slider 46, and the axial length of the tubular part 59 is substantially the same as the thickness of the flange section 52. A shaft portion of the first bolt 56 is inserted through the first retaining ring 58 and the second retaining ring 60.

A small diameter projecting shaft portion 62 having male threads on the outer circumference thereof is included on each of the pair of guide rods 48. The respective guide rods 48 are fixed to the slider 46 by screw-insertion of the projecting shaft portions 62 into the second through holes 54 of the slider 46.

Multiple sliders 46 in which the distances from the first through hole 50 to the second through holes 54 differ from each other are prepared in advance, and multiple guide rods 48 the outer diameters of which differ from each other are prepared in advance. Further, corresponding to the distances from the first through hole 50 to the second through holes 54, multiple sliders 46 which have different lengths in the longitudinal direction may also be prepared.

The guide member 16 includes a guide plate 64 and a pair of guide tubes 66. The guide plate 64 is made from iron or aluminum and is constituted from an elongated rectangular plate, including a third through hole 68 for insertion of the rod cover 24 in the center thereof, together with fourth through holes 70 for attachment of the guide tubes 66 provided on both sides thereof. Female screw threads are formed in the fourth through holes 70. Furthermore, attachment holes 72 for the purpose of attaching the guide plate 64 to an attachment member such as a wall surface or the like of another device are formed in the four corners of the guide plate 64.

The guide tubes 66 are substantially cylindrical, and include fifth through holes 74 therein for insertion of the guide rods 48. On one end in the axial direction of each of the guide tubes 66, a small diameter section 67 is formed including male screw threads for screw-engagement with the fourth through holes 70 of the guide plate 64.

The rod cover 24 is inserted through the third through hole 68 of the guide plate 64, and by screw-engagement of a lock nut 78 onto the male threaded section 38 on the end of the rod cover 24, the rod cover 24 is fixed to the guide plate 64. Two slide bearings 80 are disposed respectively in the fifth through holes 74 of the guide tubes 66. The guide rods 48 are slidably inserted in the guide tubes 66 through the pair of slide bearings 80.

Multiple guide plates 64, in which one or both of the distances from the third through hole 68 to the fourth through holes 70 and the inner radii of the fourth through holes 70 differ from each other, are prepared in advance. Further, corresponding to the distances from the third through hole 68 to the fourth through holes 70, multiple guide plates 64 which have different lengths in the longitudinal direction may also be prepared. Further, multiple guide tubes 66, in which one or both of the inner diameters and the axial length of the fifth through holes 74 differ from each other, are prepared in advance.

The guide unit 10 according to the present embodiment is constructed basically as described above. Next, a description will be given concerning a method of assembling the guide unit 10.

At first, from among the multiple sliders 46, guide rods 48, guide plates 64, and the guide tubes 66 that were prepared in advance, suitable members thereof are selected respectively corresponding to a required load. In the case that the required load is large, it is necessary for the load applied to the piston rod 22 to be alleviated, and for the operations of the actuator to be stabilized, by increasing the outer diameter of the guide rods 48, the mutual spacing (pitch) between the pair of guide rods 48, or the bearing support span of the guide rods 48.

When guide rods 48 having large outer diameters are selected, a guide plate 64 having fourth through holes 70 with inner diameters commensurate with the outer diameters of the guide rods 48 are selected, together with selecting guide tubes 66 that include fifth through holes 74 therein with inner diameters commensurate with the outer diameters of the guide rods 48. When the mutual spacing between the pair of guide rods 48 is made large, a slider 46 is selected in which the distance from the first through hole 50 to the second through holes 54 is large, and a guide plate 64 commensurate therewith is selected, and more specifically, a guide plate 64 is selected in which the distance from the third through hole 68 to the fourth through holes 70 is large. When the bearing support span of the guide rods 48 is made large, guide tubes 66 are selected in which the axial length thereof is large.

After the guide member 16 has been integrally constructed by screw-engagement of the small diameter sections 67 of the selected guide tubes 66 into the fourth through holes 70 of the selected guide plate 64, the rod cover 24 of the fluid pressure actuator 12 is inserted through the third through hole 68 of the guide plate 64. In addition, the guide member 16 and the cylinder main body 28 are made integral by screw-engagement of the lock nut 78 onto the male threaded section 38 on the end of the rod cover 24, and by screwing of the lock nut 78 until it comes into abutment against the guide plate 64.

Next, the slide member 14 is integrally constructed by screwing the projecting shaft portions 62 of the selected guide rods 48 into the second through holes 54 of the selected slider 46. Thereafter, the guide rods 48 are inserted into the fifth through holes 74 of the guide tubes 66 with the pair of slide bearings 80 being interposed therebetween. Further, in a state in which the first bolt 56, the first retaining ring 58, and the second retaining ring 60 are set (provisionally fixed) on the flange section 52 of the slider 46, the slider 46 is brought in proximity to the end surface of the piston rod 22 that extends out from the rod cover 24, and the first bolt 56 is screwed into the threaded hole 40 of the piston rod 22. More specifically, in a state in which the annular plate portion of the second retaining ring 60 is interposed between one end surface of the flange section 52 and an end surface of the piston rod 22, and the first retaining ring 58 is interposed between another end surface of the flange section 52 and a rear surface of the head of the first bolt 56, the first bolt 56 is screwed into the threaded hole 40 of the piston rod 22. Consequently, the slide member 14 and the piston rod 22 are connected together integrally.

At this time, because a predetermined gap exists between the inner circumference of the flange section 52 and the outer circumference of the tubular part 59 of the second retaining ring 60, and a floating structure is provided, even if attachment errors occur mutually between the piston rod 22, the rod cover 24, the guide member 16, and the slide member 14 in directions perpendicular to the axis of the piston rod 22, such errors can be absorbed by the floating structure. Using the attachment holes 72 of the guide plate 64, the guide unit 10, which has been assembled in the forgoing manner, is attached by bolts to a wall surface or the like of another device, not shown.

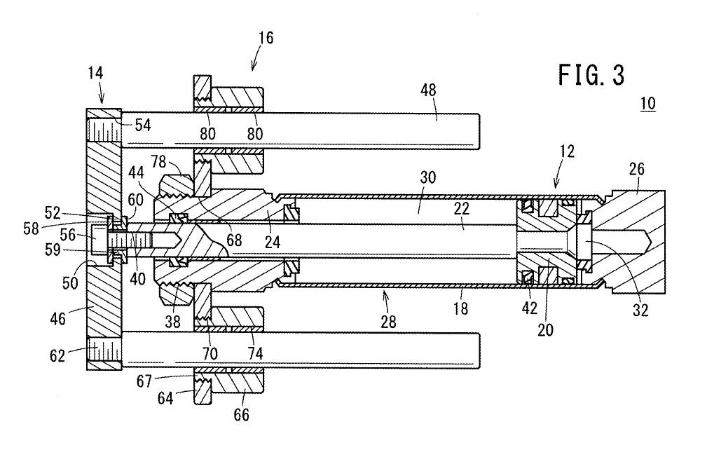

Next, advantages and effects of the fluid pressure actuator 12 will be described. The condition shown in FIG. 3, in which the piston rod 22 is retracted and accommodated in the interior of the cylinder main body 28, will be described as an initial position.

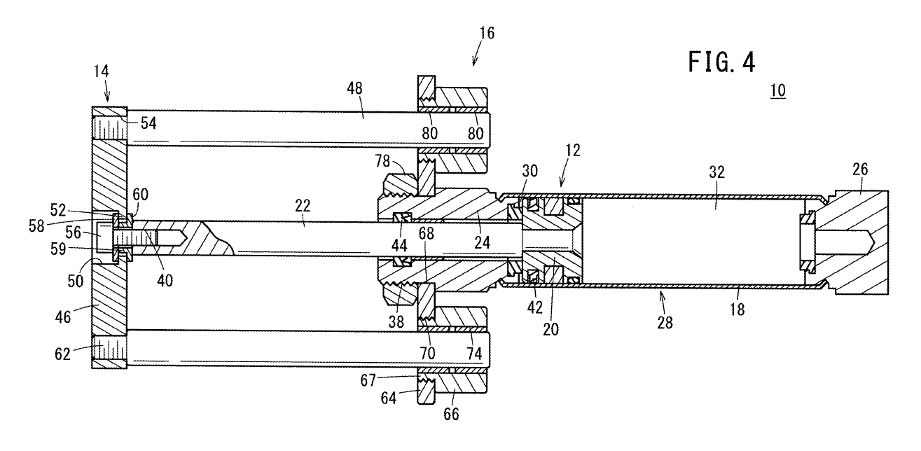

In the initial position, when air is supplied through the second port 36 to the second pressure chamber 32, together with the air of the first pressure chamber 30 being discharged through the first port 34, the piston 20 slides toward the rod cover 24. Consequently, the piston rod 22 and the slide member 14 that is integrated with the piston rod 22 are extended in a direction that the slide member 14 separates away from the cylinder main body 28 (see FIG. 4), and transporting or the like of a non-illustrated workpiece at a location of the slider 46 is carried out.

At this time, the pair of guide rods 48, which are separated from each other in parallel by a predetermined distance, are slidably guided within a support span of the predetermined length in the guide member 16 that is fixed to a wall surface or the like of another device, and therefore, even if a load is received by the slider 46 in a direction transverse to the axis of the piston rod 22, an excessive load such as a twisting or torsional load or the like is not imparted to the piston rod 22.

According to the present embodiment, although the guide tubes 66 are fixed to the guide plate 64 by screw fitting, insofar as a means is provided that enables the guide plate 64 and the guide tubes 66 to be freely fixed and detached from one another, another means may be used, such as, for example, a bolt or a retaining ring. This is because, assuming that the guide plate 64 and the guide tubes 66 can freely be fixed and detached from one another, then when the combination of the guide plate 64 and the guide tubes 66 is modified, it is possible for one of such members to be reused.

Further, according to the present embodiment, although the slider 46 is connected to the piston rod 22 through a floating mechanism made up from the first retaining ring 58 and the second retaining ring 60, etc., connection of the slider 46 with respect to the piston rod 22 may utilize another fixing means such as a bolt, a nut, or the like.

Furthermore, according to the present embodiment, although the guide rods 48 are fixed to the slider 46 by screw fitting, fixing of the guide rods 48 with respect to the slider 46 may be performed using another means such as bolts, caulking, welding, or the like.

In the case that the guide rods 48 are fixed to the slider 46 by bolts, and the slider 46 is fixed to the piston rod 22 by a bolt, recessed grooves that extend in a longitudinal or lateral direction of the slider 46 may be formed in a plate surface of the slider 46, and the heads of the bolts may be accommodated in such recessed grooves.

In accordance with the guide unit 10 according to the present invention, by changing the combination of the slider 46, the guide rods 48, the guide plate 64, and the guide tubes 66, it is possible to easily modify in a desired manner the outer diameter of the guide rods 48, a mutual spacing between the guide rods 48, or a bearing support span of the guide rods 48. Further, the slider 46, the guide rods 48, the guide plate 64, and the guide tubes 66 can be provided with simple configurations, respectively. Furthermore, since the slider 46 is connected to the piston rod 22 through the floating mechanism, even if attachment errors occur mutually between the piston rod 22, the cylinder main body 28, the guide member 16, and the slide member 14 in directions perpendicular to the axis of the piston rod 22, such errors can be absorbed by the floating mechanism.

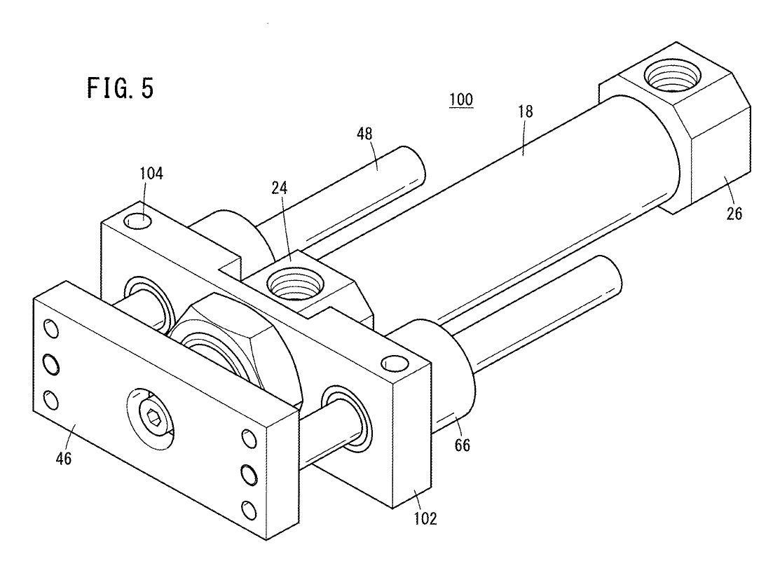

Next, a guide unit 100 according to a second embodiment will be described with reference to FIG. 5. The guide unit 100 according to the present embodiment differs from the guide unit 10 according to the first embodiment only in relation to the guide plate. Constituent elements thereof, which are the same as those of the guide unit 10 according to the first embodiment, are denoted by the same reference characters, and detailed description of such features is omitted. The same applies to the other embodiment to be described below.

The guide plate 102 is an elongated rectangular plate, which is formed to be thick-walled apart from a center portion thereof in the longitudinal direction where the rod cover 24 is attached. In addition, in the vicinity of both ends in the longitudinal direction, attachment holes 104 are formed therein, which penetrate from a side end surface of one long side of the guide plate 102 to a side end surface of another long side of the guide plate 102. The guide unit 100 is attached along a wall surface or the like of another device using the pair of attachment holes 104.

In accordance with the guide unit 100 according to the present embodiment, in addition to obtaining the same advantages and effects as the guide unit 10 according to the first embodiment, the guide plate 102 can be made with a simple structure, and further, it is easy to attach the guide unit 100 along a wall surface or the like of another device.

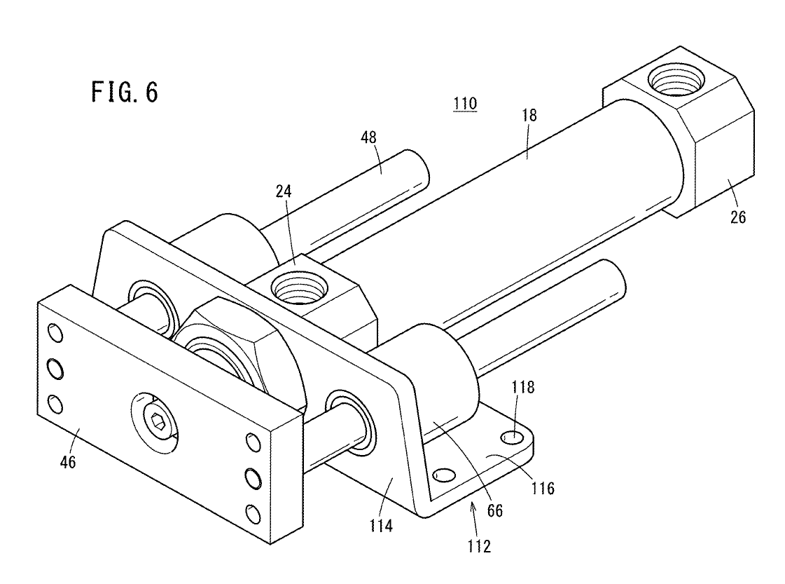

Next, a guide unit 110 according to a third embodiment will be described with reference to FIG. 6. The guide unit 110 according to the present embodiment differs from the guide unit 10 according to the first embodiment only in relation to the guide plate.

The guide plate 112 is made up from a plate member having an L-shape in cross section, including a first plate section 114, which is substantially perpendicular to the guide rods 48, and a second plate section 116, which is bent roughly perpendicularly from the first plate section 114 and lies substantially parallel to the guide rods 48. Attachment holes 118 that penetrate in a thickness direction are formed in the vicinity of the four corners of the second plate section 116. The guide unit 110 is attached along a wall surface or the like of another device using the four attachment holes 118.

In accordance with the guide unit 110 according to the present embodiment, in addition to obtaining the same advantages and effects as the guide unit 10 according to the first embodiment, the manufacture of the guide plate 112 is simple, and further, it is easy to attach the guide unit 110 along a wall surface or the like of another device.

The guide unit for an actuator according to the present invention is not limited to the embodiments discussed above, and it is a matter of course that various alternative or additional structures could be adopted therein without departing from the essential scope of the invention as set forth in the appended claims. For example, instead of the fluid pressure actuator, actuator may be adopted in which a rod is driven reciprocally by a motor.

1. A guide unit for an actuator including a slide member and a guide member, wherein:
the actuator comprises a drive rod that extends out from a cylinder main body;
the slide member includes a slider that is connected detachably to the drive rod, and a guide rod that is fixed to the slider;
the guide member includes a guide plate that is fixed to the cylinder main body, and a guide tube that is fixed to the guide plate; and
the guide rod is inserted slidably through the guide tube.

2. The guide unit for an actuator according to claim 1, wherein the guide plate is constituted from a rectangular plate member, with attachment holes that penetrate in a thickness direction being formed in corners thereof.

3. The guide unit for an actuator according to claim 1, wherein the guide plate is constituted from a rectangular plate member, with attachment holes formed therein that penetrate from one side end surface to another opposite side end surface.

4. The guide unit of an actuator according to claim 1, wherein the guide plate is constituted from a plate member having an L-shape in cross section, including a first plate section substantially perpendicular to the guide rod and a second plate section substantially parallel to the guide rod, and with attachment holes formed therein that penetrate in a thickness direction of the second plate section.

5. The guide unit for an actuator according to claim 1, wherein the slider is connected to the drive rod through a floating mechanism.

6. The guide unit for an actuator according to claim 1, wherein the guide tube is fixed to the guide plate by any one of a bolt, screw fitting, and a retaining ring.

7. The guide unit for an actuator according to claim 1, wherein the slider is fixed to the drive rod by a bolt or a nut.

8. The guide unit for an actuator according to claim 1, wherein the guide rod is fixed to the slider by any one of a bolt, screw fitting, caulking, and welding.
